(19) United States
(12) Patent Application Publication
(10) Pub. No.: US 2010/0160039 A1
(43) Pub. Date: Jun. 24, 2010

(54) OBJECT MODEL AND API FOR GAME CREATION

(75) Inventors: Adam D. Nathan, Redmond, WA (US); Chi Wai Wong, Bellevue, WA (US); Benjamin J. Anderson, Seattle, WA (US); Timothy S. Rice, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/337,662

(22) Filed: Dec. 18, 2008

(51) Int. Cl. A63F 13/00; G06F 3/048; G06F 19/00

(52) U.S. Cl. 463/31; 715/839; 463/43

(57) ABSTRACT

A game creator provides a set of abstractions (objects) that make game creation simpler. The abstractions provided in the game creation component include Game, Scene, and Actor. A Game abstraction comprises global settings for the game and includes one or more Scenes. Each Scene abstraction within the game includes one or more Actors. By setting properties and behaviors on these three abstractions, Game creators with little or no skill in programming can create games. Filtering can be performed declaratively through selection of appropriate options.

### BACKGROUND

In the early days of video games, a single person would sometimes create a video game. Today, game development frequently requires the skills of both programmers and graphic designers or artists. As platforms have become more complex and powerful, larger teams have been needed to generate all of the art, programming, cinematography, and so on needed for today's video game. Today, a video game development team can range in size from five to fifty people or more.

In traditional game development environments the game creator has to build games from low-level components. This process requires a considerable amount of programming skill.

### SUMMARY

A video game creation component provides a set of abstractions (objects) that make game creation simpler. The abstractions provided in the game creation component include Game, Scene, and Actor. By setting properties and behaviors on these three abstractions, users with little to no skill in programming can create games. Specific methods and properties for these objects include velocity, rotation, scale, index, mass and opacity. Methods for the Scene or Actor include loading and unloading and attaching and detaching event handlers. Predefined events include loading, unloading, what happens when collisions take place and property change events. Filtering can be performed declaratively through selection of appropriate options on a user interface. A Game abstraction comprises global settings for the game and includes one or more Scenes. Each Scene abstraction within the game includes one or more Actors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a is a block diagram of an example of a game creation system in accordance with aspects of the subject matter disclosed herein;

FIGS. 1b-e are block diagrams showing relationships between Games, Scenes and Actors and their properties and methods in accordance with aspects of the subject matter disclosed herein;

FIGS. 2a-f illustrate examples of user interface displays in accordance with aspects of the subject matter disclosed herein;

FIG. 3 is a flow diagram illustrating an example of a method for creating a Game in accordance with aspects of the subject matter disclosed herein;

FIG. 4 is a block diagram of an example of a computing environment in which aspects of the subject matter disclosed herein may be implemented; and

FIG. 5 is a block diagram of an example of an integrated development environment in accordance with aspects of the subject matter disclosed herein.

### DETAILED DESCRIPTION

### Overview

Many people would like to try to create video or computer games but lack the training and skill to do so. Most programming systems for creating games are either targeted at professional programmers with years of experience or at computer science students who are trying to learn the fundamentals of programming. Because of this set of target customers, many game creation systems are complex and can take a considerable amount of time to learn and require a game creator to have programming ability. At the other extreme are game creation systems that severely limit what a beginning user can do by not exposing the underlying object system to them. The subject matter described herein includes a video or computer game creation component comprising a set of abstractions that lie between these two extremes and are more approachable for a first-time game creator, enabling less-skilled users to quickly create video games.

### Object Model and API for Game Creation

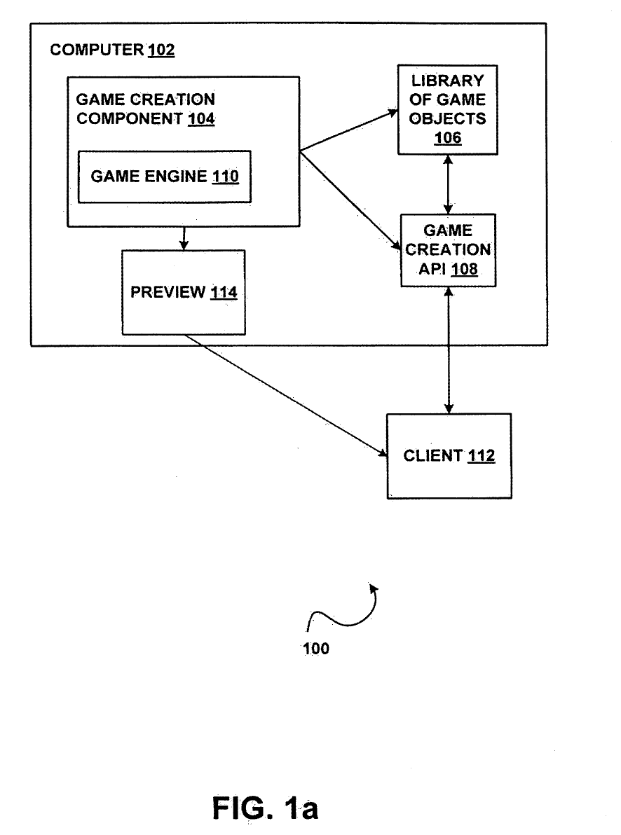

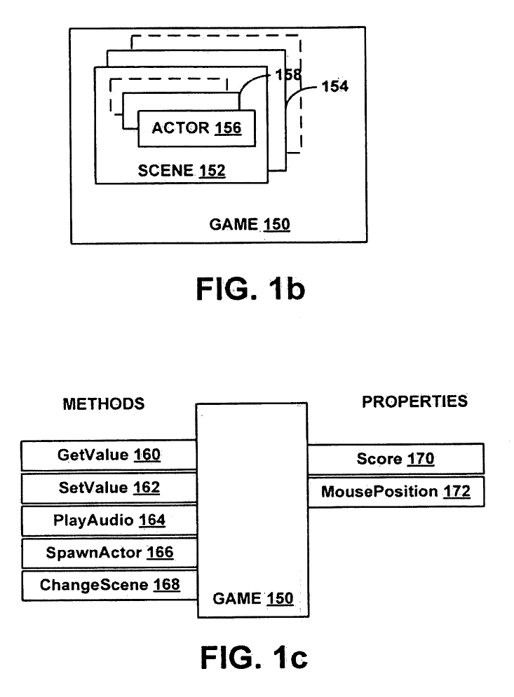

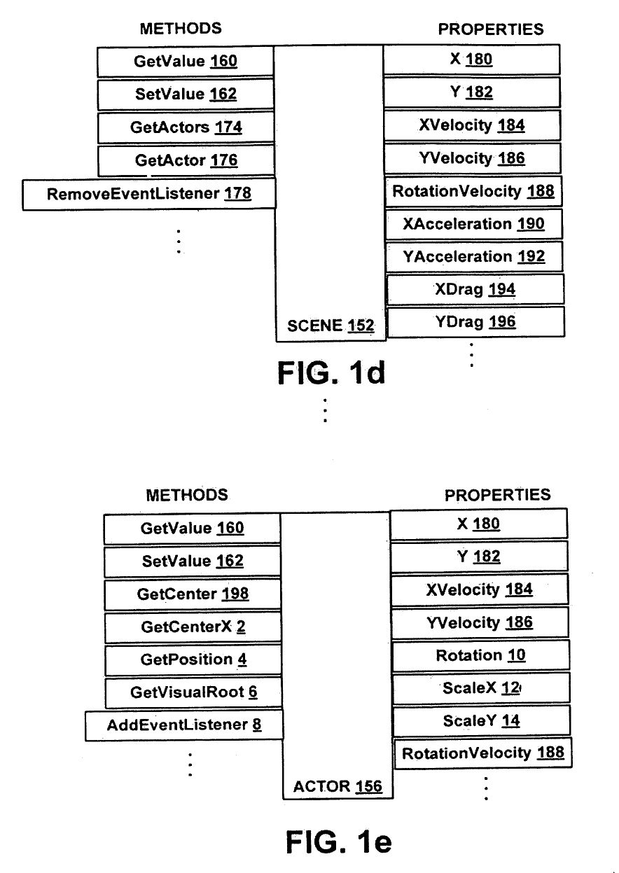

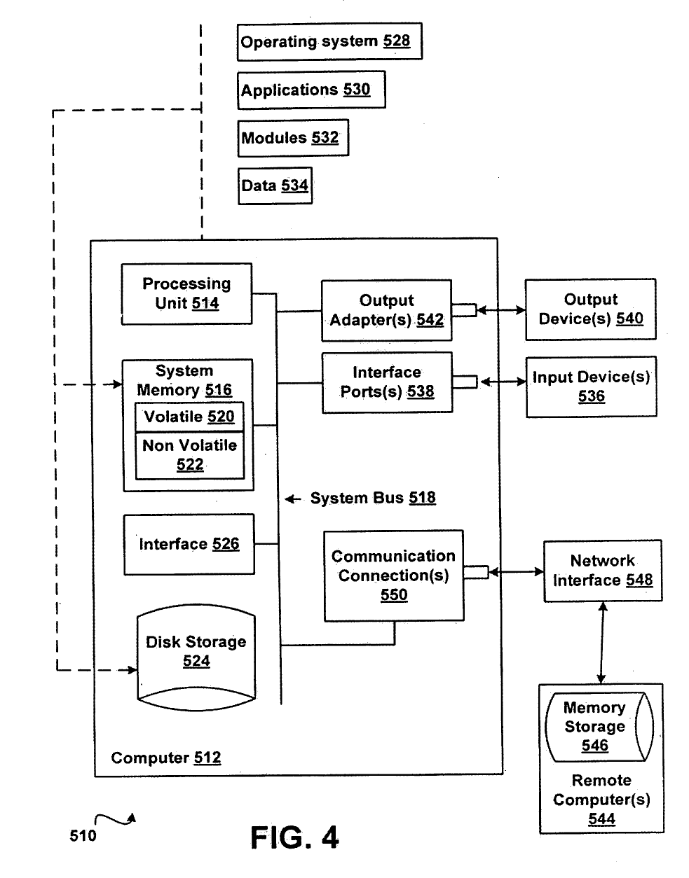

FIG. 1a illustrates an example of a system 100 that provides an object model and APIs (application programming interfaces) for game creation. System 100 may include one or more of the following: a game creation component 104 executed by a processor of a computer 102 such as a computer described with respect to FIG. 4, the game creation component 104 exposing an object model for game creation via a set of application programming interfaces (APIs) 108 accessible from a client computer such as client computer 112, a library 106 that stores objects of the object model exposed by the game creation component 104, (e.g., images, Actors, Scenes, Games, sounds, etc.), a library for storing Game objects which may be the same as library 106 or which may be a separate library and a game engine 110 that generates a game executable based on the input provided by a Game creator via the set of APIs 108. The game engine 110 may be a separate component or may be incorporated into the game creation component 104.

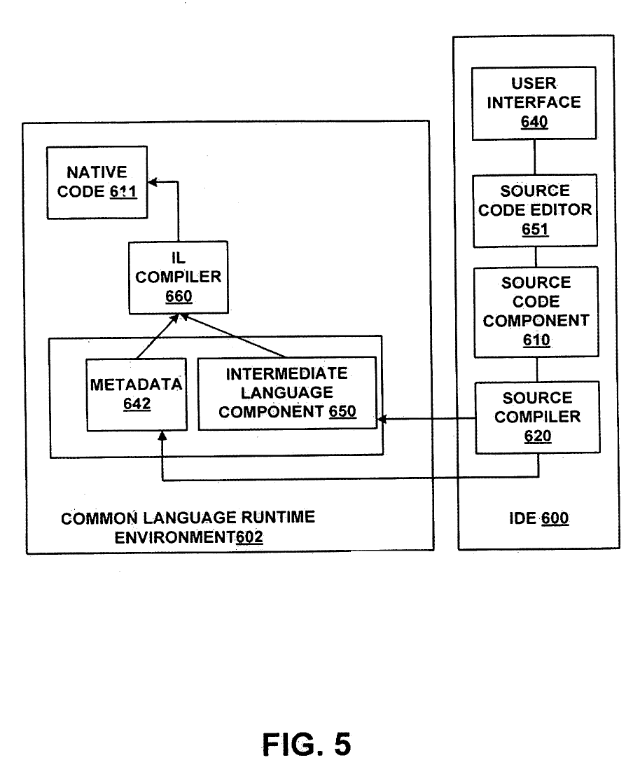

A Game creator (human) may access the game creation component 104 from a client computer 112, for example, from a web browser. Alternatively, the game creation system may be loaded onto a user's computer or may be a part of a development environment such as one described below with respect to FIG. 5. The game engine 110 may receive the game creator's input via the set of APIs 108 or the input received via the set of APIs 108 may be transformed into a file such as a text file, a Script file or an XML file, the file generated from the Game creator's input. A preview 114 of the Game may be generated as the Game is under development and may be displayed on the client computer 112 (e.g., to assist the Game creator in the development of the Game).

The object model exposed by game creation component 104 includes a set of abstractions (objects and APIs) that make it easier for a game creator to create games. Objects in the object model include the following types of objects: Game, Scene and Actor. FIGS. 1b-e show the relationship between Game objects, Scene objects, Actor objects and their properties and methods. FIG. 1b shows the relationships between a Game object 150, Scene objects 152, 154, etc. within the Game object 150 and Actors objects 156, 158, etc. within the Scenes. A Game, as illustrated in FIG. 1b, may include one or more Scenes. A Scene may include one or more Actors. Actors within one Scene are not necessarily the same as the Actors within another Scene of the Game, although all the Scenes of the Game may include the same Actors.

A Game object 150, illustrated in FIG. 1c, is a global object having user-defined global properties (accessible via a GetValue 160 method and a SetValue 162 method) as well as built-in properties like Score 170 and MousePosition 172, methods for playing audio such as PlayAudio 164, methods for changing scenes such as ChangeScene 168, methods for spawning actors such as SpawnActor 166, and so on. The Game object persists between Scenes and is responsible for transitioning between Scenes, for the instantiation of Actors, and for maintaining Game-level properties.

Game object methods include:

GetValue 160, having the parameter Property (e.g. PropertyName) of data type String and is the name of the property to be retrieved. It can return the value of the specified property and can return any type of data. GetValue is used in the Game to retrieve a particular property from the current Game object. An example in JavaScript follows:

var curScore=Game.GetValue(“Score”);

This statement retrieves the current Score property value in the Game.

SetValue 162, having the parameter Property (e.g. PropertyName) of data type String and is the name of the property to be set. It can set the value of the specified property to any type of data. GetValue is used in the Game to set a particular property on the current Game object. An example in JavaScript follows:

Game.SetValue(“Score”, Game.GetValue(“Score”)+10);

This statement increases the value of Score by 10.

Other Game object methods include:

PlayAudio 164, a method having the parameters, url and repeat. Url is a property of type string and holds the address containing the audio file played during the game. Repeat is a Boolean property, which, when set to the value “True”, repeats the audio (WMA or MP3 file) indefinitely during the Game.

SpawnActor 166, a method having the parameter params of type propertyBag which represents the name of the property to be set. This method returns Actor, the spawned actor. The params property bag includes:

| Property | Type | Description |
|---|---|---|
| actor | String | Name of the actor type to be spawned |
| x | number (optional) | x location of the spawned actor |
| y | number (optional) | y location of the spawned actor |
| effect | property bag | contains two boolean flags, scale and fade. |

SpawnActor spawns the actor specified by the parameter onto the current Scene.

ChangeScene 168 is another Game object method having the parameter newSceneName of type String. NewSceneName is the name of the scene to change to. ChangeScene, as its name suggests, changes the scene to the one specified.

Game object properties include:

MousePosition 172, which includes two subproperties: X and Y. Together the subproperties describe the current location of the mouse relative to the scene. A JavaScript example can be:

var curMouseX = Game.MousePosition.X;
var curMouseY = Game.MousePosition.Y;

These statements retrieve the game player's current mouse position relative to the game.

CurrentScene references the current active scene (e.g., Intro, Main or Lost).

FIG. 1d illustrates some of the methods and properties of a Scene object, such as Scene object 152. A Scene object encapsulates a particular scene in the Game object 150. Like the Game object, a Scene object can have properties. Properties of a Scene object persist over the duration of the Scene and do not persist after the Scene is over. A reference to the Scene has to be provided (e.g., Game.CurrentScene) before the Scene can be played. A Scene object has a number of built-in properties such as Width/Height, as well as user-defined properties (accessible via the GetValue/SetValue methods described above with respect to the Game object). A scene may have a Viewport property, which can be used to restrict the area of the Scene visible at any particular point in time. A Scene has properties for controlling Viewport location and motion including properties: X 180, Y 182, ViewportWidth, ViewportHeight, XVelocity 184, YVelocity 186, RotationVelocity 188, XAcceleration 190, YAcceleration 192, RotationAcceleration, XDrag 194, YDrag 196, and RotationDrag). A Scene has methods for retrieving all its actors or retrieving a specific actor (GetActors 174/GetActor 176 methods) and methods for attaching and detaching event handlers (AddEventListener/RemoveEventListener 178). A Scene may include one or more Actors objects. A Scene may also be associated with one or more behaviors. Scene behaviors are similar to Actor behaviors, described more fully below. Scene behaviors include scene load events, reactions to the current Game state. For example, a Scene behavior may move the Viewport of the Game or may change the Game to a new Scene. A Scene behavior may also modify Scene level properties (such as Score if a Score property were defined at a Scene scope, for instance).

The Scene property X 180 is a floating-point number representing the distance in Silverlight pixels or in other units of measure from the left side of the scene to the current position of the left side of the movable viewport. The Scene property Y 182 is a floating-point number representing the distance in Silverlight pixels or other measurement units from the top side of the scene to the current position of the top side of the movable viewport. The Scene property XVelocity 184 is a floating-point number representing the number of Silverlight pixels per second or other measurement rate that the viewport is moving (get) or is to move (set) to the right (movement to the right is denoted by a positive value for XVelocity 184) or left (movement to the left is denoted by a negative value for XVelocity 184). Changes from frame to frame may be based on the XDrag 194 property (described more fully below). The Scene property YVelocity 186 is a floating-point number representing the number of Silverlight pixels per second or other measurement rate that the Viewport is moving (get) or is to move (set) to the bottom (movement towards the bottom is denoted by a positive value for YVelocity 186) or top (movement towards the top is denoted by a negative value for YVelocity 186). Changes from frame to frame are based on YDrag 196 (described more fully below).

The Scene property RotationVelocity 188 is a floating-point number representing the number of degrees per second the Viewport is moving (get) or is to move (set) clockwise (movement in a clockwise direction is denoted by a positive value for RotationVelocity 188) or counter-clockwise (movement in a counter-clockwise direction is denoted by a negative value for RotationVelocity 188). Changes from frame to frame are based on RotationDrag (see XDrag 194 described more fully below). The property XAcceleration 190 is a floating-point number representing the number of Silverlight pixels per second or other measurement rate the Viewport is accelerating (get) or is to accelerate (set) to the right per second (when XAcceleration 190 is a positive value) or left per second (when XAcceleration 190 is a negative value). XAcceleration 190 is reset to zero every frame unless XAcceleration 190 is set during that frame. The Scene property YAcceleration 192 is a floating-point number representing the number of Silverlight pixels per second or other measurement rate the Viewport is accelerating (get) or is to accelerate (set) towards the bottom (when YAcceleration 192 is a positive value) or towards the top (when YAcceleration 192 is a negative value). YAcceleration 192 is reset to zero every frame unless set during that frame.

The Scene property XDrag 194 is a floating-point number in the range of 0 to 1.0. Conceptually, drag is what slows an object down when it starts moving or is moving. In accordance with aspects of the game creation system described herein, XDrag 194 refers to a multiplier for XVelocity 184 and is applied as an acceleration in the opposite direction of XVelocity 184. For example, if XDrag 194 is 0.5, and an object is moving right at a speed of 100, an acceleration of 50 will be applied opposite the direction the object is moving to slow the object down. If XDrag 194 is 0, motion will continue in the left-right directions at the same speed until something occurs to change it. When the value of XDrag 194 is 1, motion would be frozen by the normal rules, but instead, the acceleration value is applied directly to velocity so that if an XAcceleration 190 of 500 is applied, the object will move right at 500 Silverlight pixels a second or at 500 units of some other measurement rate. The property YDrag 196 is a floating-point number from 0 to 1.0 and is treated in a fashion similar to XDrag 194 except in a vertical direction.

A Scene object 152 has methods for retrieving its actors or a specific actor (GetActors 174/GetActor 176 methods) and methods for attaching and detaching event handlers (AddEventListener/RemoveEventListener 178). A Scene may include one or more Actor objects. The Scene object method GetValue 160 has a parameter propertyName of data type String which represents the name of the property to be retrieved. GetValue 160 returns the value of the specified property, and can be of any type. GetValue 160 retrieves a particular property from the Scene. An example in JavaScript may be:

var curScene = Game.CurrentScene;
var curSceneX= curScene .GetValue(“X”);

These statements retrieve the number of Silverlight pixels (or other unit of measurement) the viewport is offset from the left side of the currently active scene.

The Scene method SetValue 162 has a parameter propertyName of data type String and represents the name of the property to be set. It also has the parameter value which can be of any data type and is the value to which the specified property is to be set. SetValue 162 sets a particular property on the Scene. An example in JavaScript may be:

var curScene = Game.CurrentScene;
curScene.SetValue(“X”, 5);

These statements set the offset of the viewport from the left corner of the currently active scene to a particular number (e.g., five in the example above) of Silverlight pixels (or other unit of measurement).

A Scene may include one or more Actors objects. Because there can be multiple instances of the same Actor (for example, there may be 10 enemy spaceships), two methods are provided to retrieve Actor objects, GetActors and GetActor. The GetActors method retrieves every active instance based on the Actor name (e.g., GetActors(“Spaceship”) retrieves each of the ten instances of the “Spaceship” Actor. Each instance also has an instance name such as “Spaceship 1”, “Spaceship 2” and so on. GetActor uses the actor instance name to retrieve a particular actor instance. The Scene method GetActors 174 accepts a parameter Actors of data type String which represents the Actor Name to get. It returns a list of Actors comprising all currently active instances of the Actor whose name is passed in. An example in JavaScript may be:

var curScene = Game.CurrentScene;
var actors = curScene.GetActors(“Spaceship”);

These statements retrieve a list of all active instances of the Spaceship actor.

The Scene method GetActor 176 accepts a parameter Actor of data type String which holds the name of a particular actor instance to retrieve. GetActor 176 returns a parameter Actor, the retrieved actor based on the actor name passed in to the GetActor 176 method. GetActor 176 retrieves an actor based on the actor instance name passed in. An example in JavaScript may be:

var curScene = Game.CurrentScene;
var actor = curScene.GetActor(“Spaceship 1”);

These statements retrieve the specific instance of actor Spaceship, “Spaceship 1” if it exists and is active in the current scene.

An Actor object, such as Actor object 156 of FIG. 1e, may also have a number of built-in properties including:

X 180, XVelocity 184, XAcceleration 190, XDrag 194,

Y 182, YVelocity 186, YAcceleration 192, YDrag 196,

Rotation 10, RotationVelocity 188, RotationAcceleration, RotationDrag,

ScaleX 12, ScaleXVelocity, ScaleXAcceleration,

ScaleY 14, ScaleYVelocity, ScaleYAcceleration,

ZIndex,

Mass and

Opacity.

In addition an Actor object may have user-defined properties (accessible via GetValue 160/SetValue 162 methods). Methods for attaching and detaching event handlers (AddEventListener and RemoveEventListener 178) are also provided.

The Actor property X 180 is a floating-point number that represents the distance from the left side of the scene in Silverlight pixels or in another measurement unit. The Actor property Y 182 is a floating-point number that represents the distance from the top side of the scene in Silverlight pixels or in another measurement unit. The Actor property Rotation 10 is a floating-point number that represents the number of degrees clockwise from the vertical (straight up) an Actor is turned. The Actor property ScaleX 12 is a floating-point number that is a multiplier against the original width of the actor. The Actor will display with ScaleX 12 original width as its width. That is, when ScaleX 12 is 1.0, the Actor's width is unchanged from the original. When ScaleX 12 is 0.5, the Actor will be half its original width and when ScaleX 12 is 2.0, the Actor will be twice its original width. The Actor property ScaleY 14 is a floating-point number that is a multiplier against the original height of the actor. The actor will display with ScaleY 14 original height as its height. That is, when ScaleY 14 is 1.0, the actor's height is unchanged from the original. When ScaleY 14 is 0.5, the Actor will be half its original height and when ScaleY 14 is 2.0, the Actor will be twice its original height.

The Actor property XVelocity 184 is a floating-point number representing the number of Silverlight pixels per second or other measurement rate the Actor is moving (get) or is to move (set) to the right (when XVelocity 184 is a positive value) or left (when XVelocity 184 is a negative value). Changes from frame to frame are based on XDrag (described more fully below). The Actor property YVelocity 186 is a floating-point number representing the number of Silverlight pixels per second or other measurement rate the Actor is moving (get) or is to move (set) to the bottom (when YVelocity 186 is a positive value) or top (when YVelocity 186 is a negative value). Changes from frame to frame are based on YDrag (described more fully below). The Actor property RotationVelocity 188 is a floating-point number representing the number of degrees per second the Actor is moving (get) or is to move (set) clockwise (when RotationVelocity 188 is a positive value) or counter-clockwise (when RotationVelocity 188 is a negative value). Changes from frame to frame are based on RotationDrag (see XDrag for more information).

The Actor property ScaleXVelocity is a floating-point number representing the amount per second the Actor is scaling (get) or is to scale (set) along the Actor's width (on the X-axis). Changes from frame to frame are based on ScaleXAcceleration and ScaleXDrag (see ScaleXAcceleration and XDrag for more information). The Actor property ScaleYVelocity is a floating-point number that represents the amount per second the Actor is scaling (get) or is to scale (set) along the Actor's height or Y-axis. Changes from frame to frame are based on ScaleYDrag (see YDrag for more information). The Actor property XAcceleration is a floating-point number representing the number of Silverlight pixels per second or other measurement rate more the Actor is accelarating (get) or is to accelerate (set) to the right per second (when XAcceleration is set to a positive value) or left per second (when XAcceleration is set to a negative value). XAcceleration is reset to zero every frame unless set during that frame.

The Actor property YAcceleration is a floating-point number representing the number of Silverlight pixels per second or other measurement rate more the Actor is accelerating (get) or is to accelerate (set) towards the bottom (when YAcceleration is a positive value) or towards the top (when YAcceleration is set to a negative value). YAcceleration is reset to zero every frame unless set during that frame. The Actor property RotationAcceleration is a floating-point number representing the number of degrees per second the Actor is accelerating (get) or is to accelerate (set) clockwise (when RotationAcceleration is a positive value) or counter-clockwise (when RotationAcceleration is set to a negative value). The value of RotationAcceleration is reset to zero every frame unless set during that frame.

The Actor property ScaleXAcceleration is a floating-point number representing the amount per second of acceleration of scaling (get) of the Actor or the amount of acceleration of scaling of the Actor is to occur (set) along the X-axis. The value of ScaleXAcceleration is reset to zero every frame unless set during that frame. The Actor property ScaleYAcceleration is a floating-point number that represents the amount per second of acceleration of scaling of the Actor (for a get operation) or the amount of acceleration of scaling of the Actor that is to occur (for a set operation) along the Y-axis. The value of ScaleYAcceleration is reset to zero every frame unless set during that frame.

The Actor property XDrag is a floating-point number from 0 to 1.0. Conceptually, drag slows an Actor down when it starts moving. In accordance with aspects of the subject matter disclosed herein, XDrag refers to a multiplier against XVelocity 184 which is applied as an acceleration in the opposite direction of XVelocity 184. For example, if XDrag is 0.5, and an Actor is moving right at a speed of 100, an acceleration of 50 will be applied opposite the direction the Actor is moving to slow the Actor down. If XDrag is zero, motion will continue in the left-right directions at the same speed until something occurs to change it. When XDrag is 1, motion would be frozen if the normal rules were applied. Instead, the acceleration value is applied directly to velocity so that if an XAcceleration of 500 is applied, the Actor will move right at 500 Silverlight pixels per second or if another unit of measurement is used, at that rate.

The Actor property YDrag is a floating-point number from 0 to 1.0 and is treated in a fashion similar to XDrag except in a vertical direction. The Actor property RotationDrag is a floating-point number from 0 to 1.0. See XDrag for more information. The Actor property ZIndex is a number that determines which Actors are drawn on top of which other Actors. Any Actor with a lower ZIndex will get drawn behind an Actor with a higher ZIndex. If both Actors have the same ZIndex, the Actor added to the scene last will be drawn on top. The Actor property Mass is a number that determines which Actor will move during a collision. The Actor with the lower mass will be moved while the Actor with higher mass will continue moving as it was (or will remain stationary if it was stationary). If both Actors have equal mass, the one moving faster will push the slower moving Actor. The Actor property Opacity is a number from 0 to 1. Opacity determines the degree of transparency of an Actor. When Opacity is 1, nothing behind the Actor will be visible. When Opacity is 0, the Actor will be invisible and only what is behind the Actor is visible. The closer to 1 the less (in terms of transparency) of what is behind an Actor will be visible and the closer to 0, the more of what is behind an Actor will be visible.

An Actor object has a GetPosition 4 method (for the top/left corner) and a GetCenter 198 method. An actor can have one or more States, and correspondingly can have a ChangeState method and a CurrentState property. An Actor can also have methods for attaching and detaching event handlers (AddEventListener 8/RemoveEventListener). An Actor can have a Remove method for removing themselves from the scene (with an optional visual/sound effect) and IsOffScene/IsOffViewport properties. Actors also have a GetVisualRoot 6 method for interacting with the technology used to describe and update the visual appearance of the Actor. (In some implementations, this technology is Silverlight, but this could be used to access the underlying representation of the visual in other programming models such as OpenGL, DirectX, XNA Game Studio, XNA, Flash, etc.) Actors can be “solid” or “non-solid.” In the former case, physics is automatically applied to ensure that no two solid objects overlap. Actors have edges that describe their bounds for physics as well as for events related to entering and leaving a scene or viewport. The Mass property is a simple numeric ranking to determine which solid object “wins” when there is a collision.

The GetValue 160 Actor method has a parameter propertyName of data type String representing the Name of the property to be retrieved. GetValue 160 returns the value of the specified property and can be of any type. GetValue 160 retrieves a particular property from the Actor. An example in JavaScript may be:

var curActor = Game.CurrentScene.GetActor(“Spaceship 1”);
var curActorX= curActor.GetValue(“X”);

These statements assign to curActorX the number of Silverlight pixels (or other unit of measurement) from the left edge of the screen to the left edge of actor instance “Spaceship 1”. The Actor method SetValue 162, having parameters propertyName and value. PropertyName is of data type String and represents the name of the property to be set. Value can be of any data type and represents the value of the property. SetValue 162 sets a particular property on the actor. An example in JavaScript may be:

var curActor = Game.CurrentScene.GetActor(“Spaceship 1”);
curActor.SetValue(“X”, 5);

These statements position actor instance Spaceship 1 5 silverlight pixels (or other unit of measurement) from the left edge of the currently active scene.

The Actor method GetCenter 198 returns a point representing the location of the center point of the Actor relative to the scene. GetCenter 198 includes the X and Y component and retrieves the center point of the Actor. An example in JavaScript may be:

var curActor = Game.CurrentScene.GetActor(“Spaceship 1”);
var curActorX= curActor.GetCenter( ).X;

These statements assign to curActorX the number of pixels from the left edge of the currently active scene to the center of actor instance “Spaceship 1”.
The Actor method GetCenterY returns an integer representing the location of the center point, the Y value, of the Actor relative to the scene. GetCenter 198 retrieves the Y value of the center point of the Actor. A JavaScript example may be:

var curActor = Game.CurrentScene.GetActor(“Spaceship 1”);
var curActorY= curActor.GetCenterY( );

These statements assign to curActorY the number of pixels from the top of the currently active scene to the center of the actor instance named Spaceship 1.

The Actor method GetCenterX 2 returns an integer representing the location of the center point, the X value, of the Actor relative to the scene. GetCenterX 2 retrieves the X value of the center point of the Actor. An example in JavaScript may be:

var curActor = Game.CurrentScene.GetActor(“Spaceship 1”);
var curActorX= curActor.GetCenterX( );

These statements find the X component of GetCenter. They would be used to avoid the cost calculating the Y component when only the X is required.

The Actor method GetPosition 4 returns a point representing the location of the top left point of the Actor relative to the scene. GetPosition 4 includes the X and Y component and retrieves the top left point of the Actor. An example in JavaScript may be:

var curActor = Game.CurrentScene.GetActor(“Spaceship 1”);
var curActorX= curActor.GetPosition( ).X;

These statements are similar to calling curActor.GetValue(“X”)
The Actor method GetVisualRoot 6 returns an XML or other type of element representing the root canvas of the Actor. GetVisualRoot 6 retrieves the root canvas of the Actor. Predefined Actor methods include methods for attaching and detaching event handlers (AddEventListener 8/RemoveEventListener).

An Actor method for ChangeState accepts a parameter newStateName of data type String representing the name of the state to change to. ChangeState changes the state to the one specified. The Actor method IsOffScene returns a Boolean value. If the value is “true” the Actor is currently off-screen. IsOffScene determines if the Actor is currently offscreen. An Actor method Remove accepts an effect parameter of type propertyBag that includes two Boolean flags, scale and fadein. Remove removes the actor from the scene with the specified effect. An Actor method currentState returns an object having the following properties:

| | | |
|---|---|---|
| name | string | contains the actual name of the state. |
| width | integer | Contains the width of the Actor in this state. |
| height | integer | Contains the height of the Actor in this state. |
| isSolid | boolean | Returns true or false whether the Actor is a solid. |
| xaml | string | Returns the complete XAML value for this state. |
| egdes | uknown | unknown |

An example in JavaScript may be:

var curActor = Game.CurrentScene.GetActor(“Spaceship 1”);
var currentState = curActor.currentState.name;

These statements assign the name of the actor's current state to the variable currentState.

Actors and scenes can contain behaviors which are triggered by events. Events for Scene Objects:

Load—a Scene is loaded into the Game

KeyDown—a user presses a key on an input device. The KeyDown event is able to be filtered by one or more keys so that all key presses except a specified key press are ignored. For example, if the specified key is the “D” key, pressing any other key would be ignored.

WhileKeyDown—(able to be filtered by one or more keys, as described above)

KeyUp (able to be filtered by one or more keys, as described above)

MouseDown—a mouse button is depressed

WhileMouseDown—while the mouse button is in the state of being depressed

MouseUp—the mouse button is released

MouseEnter—a mouse click

MouseHover—hovering the mouse over an object.

Other events for Scene Objects are:

MouseLeave—cursor controlled by mouse exits a particular object location

Timer—(able to be given a regular interval, a random interval within a minimum and maximum range, or “every frame”).

Collision—(where the two objects colliding can independently be specific Actors, Actor instances, or categories of Actors like solid/non-solid, etc.).

WhileColliding (where the two objects colliding can independently be specific Actors, Actor instances, or categories of Actors like solid/non-solid, etc.).

Uncollision (where the two objects colliding can independently be specific Actors, Actor instances, or categories of Actors like solid/non-solid, etc.).

PropertyChange (where the property can be on Game, any scene, any actor, any actor instance, and the event can be filtered on any change, or a specific query (like value <=5).

Actor Objects can be associated with one or more of the following Events:

Load—an Actor is loaded onto the Scene

StateChange—An actor can have one or more states, for example, a Car Actor could have a normal (undamaged) state and a damaged state. Objects can respond to StateChange events, so for example, when the Car Actor changes to a damaged state, two points could be deducted from the Score object.

Disappear when an actor disappears, a Disappear event is raised.

SceneEnter (able to be filtered by one or more directions of entry, e.g. an Event can be raised only if the Scene is entered from the right side, the left side, from the bottom or the top.)

SceneLeave (able to be filtered by one or more directions of exit)

ViewportEnter (able to be filtered by one or more directions of entry) Viewport is a property that determines what portion of the Scene is visible at a particular point in time. Using the ViewportEnter event, for example, an enemy Actor could be stationary until the ViewportEnter event is raised (e.g., by the hero Actor entering the Viewport). When the ViewportEnter event is raised, the enemy Actor may begin to approach the hero Actor.

Other Actor events include:

ViewportLeave (able to be filtered by one or more directions of exit so that different Behaviors occur depending on the direction the Actor exits from.)

KeyDown (able to be filtered by one or more keys)

WhileKeyDown (able to be filtered by one or more keys)

KeyUp (able to be filtered by one or more keys)

MouseDown

WhileMouseDown

MouseUp

MouseEnter

MouseHover

MouseLeave

Timer (able to be given a regular interval, a random interval with a minimum and maximum range, or just “every frame”).

Collision (where the two objects colliding can independently be specific actors, actor instances, or categories of actors like solid/non-solid, etc.).

WhileColliding (where the two objects colliding can independently be specific actors, actor instances, or categories of actors like solid/non-solid, etc.).

Uncollision (where the two objects colliding can independently be specific actors, actor instances, or categories of actors like solid/non-solid, etc.).

PropertyChange (where the property can be on Game, any scene, any actor, any actor instance, and the event can be filtered on any change, or a specific query (like value <=5).

Events are associated with behaviors such that when an event occurs, its associated behavior takes place. Behaviors are described more fully below.

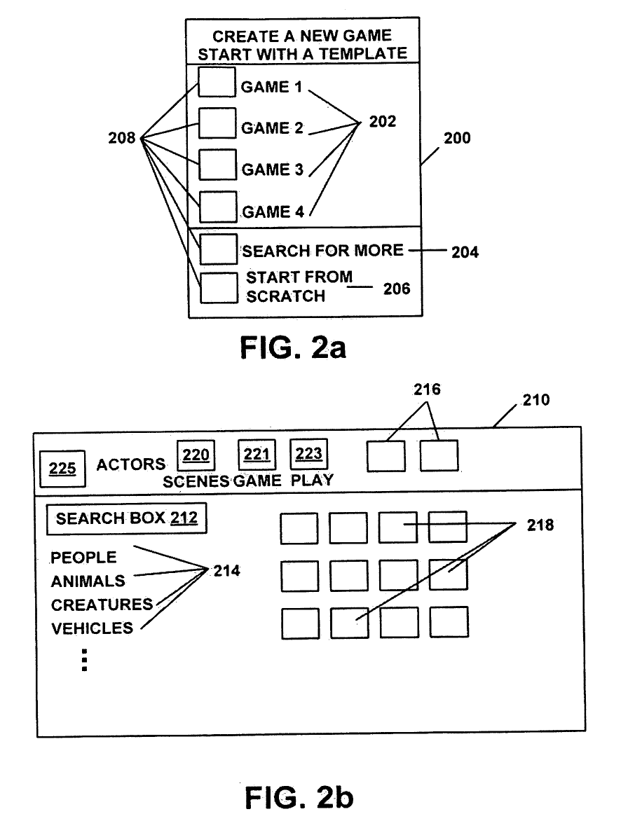

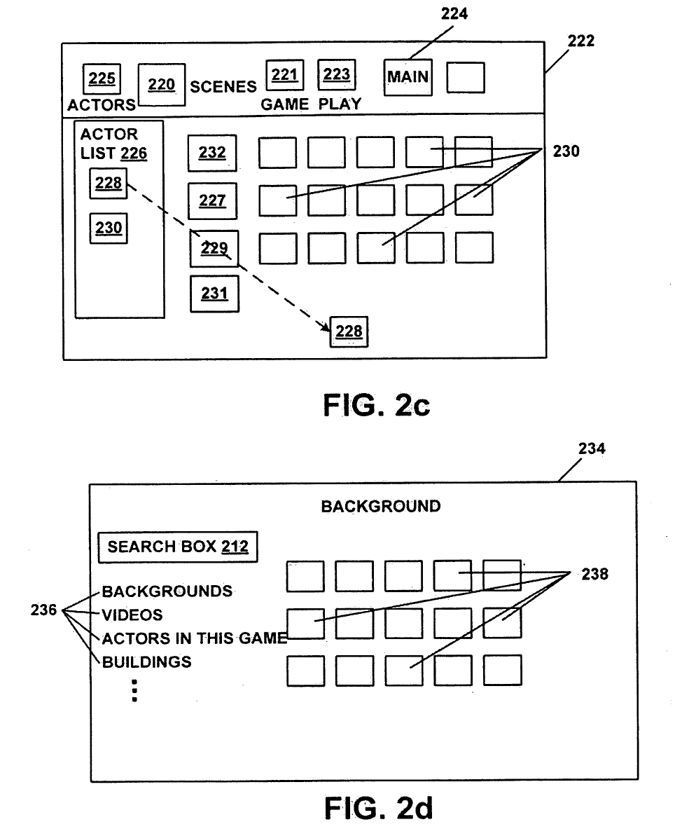

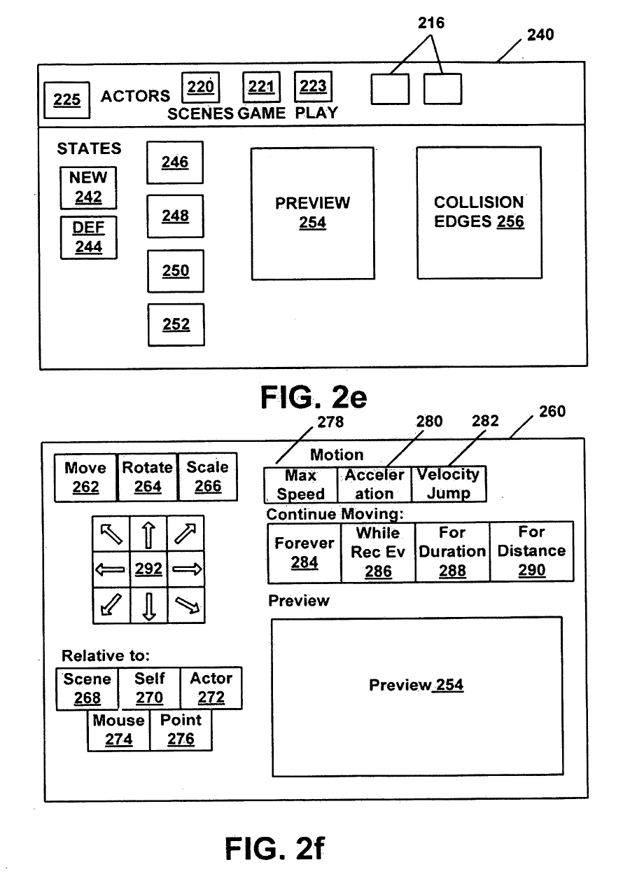

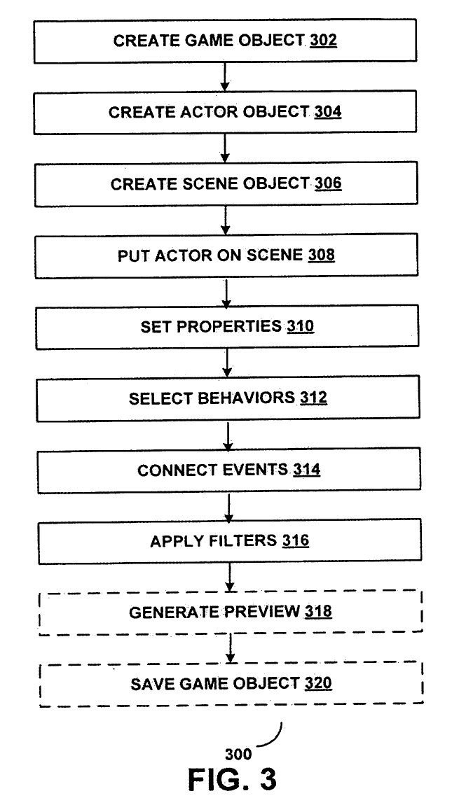

FIG. 3 illustrates an example of a method of Game creation 300 in accordance with aspects of the subject matter disclosed herein. It will be appreciated that some of the actions listed in FIG. 3 may be optional and the order of some of the actions are not fixed. Moreover some of the actions may be repeated a number of times. At 302 a Game object may be created. FIG. 2a illustrates an example of a user interface 200 which can be used to create a new Game object in accordance with aspects of the subject matter disclosed herein. It will be appreciated that all the user interfaces described herein are illustrative not limiting. The user interfaces described herein are meant to facilitate understanding. Alternative content, navigation and the like are contemplated. User interface 200 in accordance with some aspects of the subject matter disclosed herein, may provide templates of Games such as templates 202 for games such as Game1, Game2, Game3 and Game4 from which a new Game can be created, or may enable a Game template for a Game not shown to be searched for using the search for more Games option 204. User interface 200 may also provide the ability for a new Game to be created without relying on a template (i.e., “start from scratch”) 206. Images 208 may accompany each option.

At 304 one or more Actor objects are created or are selected for the Game. If a template from an existing Game is selected, the new Game can be populated with Scenes and Actors with their associated settings for properties from the existing selected Game and can then be modified using the user interfaces described below. If a Game is created from scratch, an Actor user interface such as user interface 210 of FIG. 2b may be displayed by default. Navigation options from user interface 210 may include navigation to a Scene user interface via Scene tab 220, to a Game user interface via a Game tab 221 and to a Play Game user interface via a Play tab 223. The selected tab (e.g., the Actor tab 225 on Actor user interface 210) may be enhanced to signal the identity of the current display.

Selections 214 included on this user interface may include collections of people, animals, creatures, vehicles, electronics, buildings, items from outdoors, indoor items, food, power ups, clothing, tiles, controls, projectiles, visual/sound effects, playing cards, backgrounds, videos and a category for “everything else” but are not limited thereto. One or more items from each of one or more of these collections may be selected, including a hero and an enemy Actor, for example. Images 218 of Actors can be displayed for Actors for selection. A search box 212 may be provided so that Actors of a particular type or name can be searched for. For example, entering “Spaceship” in the search box 212 may result in a display of images 218 of predefined spaceship Actors. Suppose a Fighter Spaceship is selected to be the hero and a Flying Saucer is selected to be the enemy spacecraft. The selected Actors (e.g., Fighter Spaceship (hero Actor 228 shown in FIG. 2c) and Flying Saucer (enemy Actor 230 shown in FIG. 2c) may appear in the Actors List 216, (e.g., near the top of the window).

At 306 a Scene object may be created. To place the selected Actors from Actor List 216 in a Scene, the Scene tab 220 can be selected (e.g., by a standard selection operation such as by clicking on the Scene tab 220). In response to selection of the Scene tab 220, a Scene user interface such as user interface 222 of FIG. 2c for a Scene (e.g., the Main Scene 224) may be displayed. By default, every Game may be given a configurable number of scenes (e.g., five scenes). The Scenes provided may be listed along the top of the Scene user interface displayed in response to selecting the Scene tab 220. Default Scenes may include but are not limited to an Introductory Scene, a Main Scene, a Won Scene, a Lost Scene, and a How to Play Scene). Additional Scenes can be added via a New button on the Scene user interface 222. Scenes may be removed. Instructions on how to play the Game can be provided on the “How to Play” Scene.

Available options in the Scene user interface 222 may include an option to add Actors in the Game to the current Scene and an option to draw additional Actors (not shown). Other options appearing in the Scene user interface 222 may include navigation options to a Background user interface via Background button 232, to a Behaviors user interface via Behaviors button 227, to a Properties user interface via Properties button 229 and to a Music user interface via Music button 231. Selection of the Background button 232 enables selection of backgrounds for any or all Scenes in the Game. Selection of the Behaviors button 227 allows a selection of Behaviors in the current Scene. Selection of the Properties button 229 allows a Game creator to add, edit or remove properties for the Scene. Selection of the Music button 231 allows a Game creator to select audio for the Scene. Hovering the mouse over the Music button 231 may play the selected audio for the Scene. Options to set width and height properties of the Scene, an option to magnify or diminish the visible part of the Scene, an option to turn automatic snapping of Actors to guide lines on and off and an option to enable a Viewport that is smaller than or the same size as the entire Scene may be provided.

In addition a new Scene can be added to the Game by selecting the New button (not shown). The Actor 228 and Actor 230 selected in the previous user interface (e.g., the Fighter Spaceship hero and the Flying Saucer enemy images) may appear in an Actors List display 226. At 308 one or more Actors are placed on the Scene. To place the Actors in the Scene, one of the selected Actors in the Actors List display 226 is selected and moved to a desired position in the Scene. Perhaps a game creator selects the Fighter Spaceship (hero Actor 228) and centers it at the bottom of the scene. Other Actors may be added similarly. For example, perhaps the Game creator adds 15 Flying Saucer enemy Actors 230 to the Scene, arranging them in three rows of five across, as shown in FIG. 2c.

At 310 properties are set on the Game, Scene and Actors. To add a background to the Game, a Background button 232 can be selected. In response to selection of the Background button 232, a Background user interface such as user interface 234 of FIG. 2d for the Main Scene 224 may be displayed by default. Background user interface 234 may include a search box 212 to enable a search for a particular type of Background. A list of selections 236 may be displayed. Selections may include but are not limited to collections of videos, Actors in the Game, buildings, outdoors, indoor items, tiles, people, animals, creatures, vehicles, electronics, food, power ups, clothing, controls, projectiles, visual/sound effects. Background images 238 may be displayed from which a background can be selected. Other options available on the Background user interface 234 may include a Scale button that fills the available area by scaling the background, a Tile button that fills the available area by tiling the background, a button that shows the currently selected background and a button to remove the existing background (not shown).

In response to exiting user interface 234, user interface 222 may be displayed. To add audio (e.g., music) to the Game, the Music button 231 may be selected. In response to selection of the Music button 231, a Music user interface may be displayed. Categories of music or other audio including but not limited to Classical, Country, Dance, Funk, Jazz, New Age, Pop, Reggae, Regional and Rock may be displayed. Music can be imported from the Web or from a Game creator's library and can also be the subject of a Search by selecting appropriate buttons. In response to selecting one of these categories or entering a search for a category, images of music files with descriptors (e.g., “Forest Theme”) may be displayed. A user can select desired audio and exit the music chooser dialog.

Various aspects of Actors can be modified by navigating to an Actor user interface 240, as illustrated in FIG. 2e, by selecting one of the Actors in the Actors List 216. State options include adding a new state by selecting the New button 242 or using a default state by selecting the Default button 244. From Actor user interface 240 the appearance, behaviors and the properties of the selected Actor can be modified using the Appearance button 246, the Behavior button 248, or the Properties button 250 respectively. The Actor can be exported using the Export button 252. Actor user interface 240 may also include a preview pane 254 for the Actor and a collisions edges pane 256. A preview pane 254 may display the current appearance of the Actor. The collisions edges pane 256 may be used to control the behavior of the Actor when it collides with other Actors by choosing to make it solid or non-solid, and by choosing a shape for its collision edges (round or square).

Options for changing the Actor's appearance via selection of the Appearance button 246 include a color swapper which can be used to change the colors of an Actor. An image or video can be added, text can be added to the Actor, or XML can be inserted to change the appearance of the Actor. Other properties that can be changed via selections of appropriate buttons on a user interface displayed in response to selection of the Appearance button 246 on the Actor user interface 240 include the width and height of the Actor, whether the Actor snaps to guide lines when placed in a Scene and how much of the Actor is visible in a Viewport. An Undo option may also be available via an Undo button.

At 312 Behaviors may be selected. Behaviors accessed via Behavior button 248 control interactions between Actors or other objects (for example, a behavior may control how a selected Actor interacts with other Actors in the Game, and how the selected Actor can be controlled by someone playing the Game). In accordance with aspects of the subject matter disclosed herein, the hero Actor is controlled by the person playing the Game. For example, the Game player may be able to move the hero right and left by using the arrow keys on the keyboard. Enemy Actors can be made to move without Game player input. Both user-directed and non-user directed Actors can be controlled via setting Actor behaviors.

To make an Actor in the Game move, a Game creator can navigate to the Actors user interface 240 by selecting an Actor from the Actors List 216 (e.g., the Fighter Spaceship) and selecting the Behavior button 248 on the Actors user interface 240. In response to selection of the Behavior button 248, a user interface displaying a number of options for controlling the Actor may be displayed. An Actor can be made to move by selecting a Motion button. The Actor's state can be changed by selecting a State button. The Actor can be made to disappear with an optional visual/sound effect by selecting a Disappear button. The value of a property can be changed by selecting the Property button. Custom program code can be written to enhance the Game by selecting a Custom button. The Actor can be made to shoot a projectile by selecting a Shoot button. A sound can be added by selecting a Sound button. An Actor can be made to appear with an optional visual/sound effect by selection an Appear button or navigation to a different Scene can be caused by selecting a Scene button.

In response to selection of the Motion button, a new motion behavior (e.g., Motion 1) may appear on the list of Actor behaviors. A default behavior motion, Disappear On Scene Leave may be provided. Events may be associated with the Behaviors at 314. Available options for the new motion Motion 1 may include selection of behavior that will begin as soon as the Actor appears on the scene, restrict the conditions in which the event triggers this behavior (i.e., apply a filter 316), determine a directionality for the motion, choose a sound to play for the motion, and view and/or change the code for the behavior. Available options for the default Disappear On Scene Leave motion may be selecting behavior that will be triggered when the Actor disappears from the Scene, restrict the conditions in which the event triggers this behavior (i.e., apply a filter), select a visual/sound effect to occur when the Actor disappears from the Scene, choose a sound to play for the motion, and view and/or change the code for the behavior. Selection of the Myself option specifies the current Actor for which the behavior is being defined. For example, if a collision event causes a disappear behavior to happen on Myself any instance of that Actor may disappear when colliding. This means that the disappearing behavior only affects the Actor that owns that behavior (Myself) rather that having all instances of Actors in the Scene disappear when any Actor collides. Similarly, any particular Actor may disappear regardless of which Actor was actually involved in a collision. Selection of the filter option provides the Game creator with the following options: choose a default or custom state to which the filtering behavior is applied, select which Scenes to apply the filter to, and configure values of Properties which trigger the filter.

Motions such as a “move right” behavior or any other behavior can be defined by selecting an event trigger. For example, the selected trigger for a “move right” behavior may be when a player presses down on the right arrow key as described below. In response to selecting the Event button for the new motion, a list of events that trigger the behavior such as Simple (the behavior starts upon a simple entering or exiting event), Keyboard (trigger the behavior with the Keyboard), mouse (trigger the behavior with the Mouse), Timer (trigger the behavior on a timed interval), Collision (trigger the behavior on a collision) and Change Property (trigger the behavior on a change in property) may appear.

Options for the Simple behavior include setting the behavior to begin as soon as the Actor is loaded into the Scene (Load), trigger the behavior when the Actor changes to a specific state (State Change) and start the behavior as soon as the Actor disappears from a Scene (Disappear). Other options include trigger the behavior when the Actor moves into the Scene from Off-Scene (Scene Enter), trigger the behavior when the Actor moves off the Scene (Scene Leave), trigger the behavior when the Actor moves into the Viewpoint from off-viewpoint (Viewpoint Enter) and trigger the behavior when the Actor moves off the Viewpoint (Viewpoint Leave).

Options for the Keyboard trigger include raising the event when the selected key is first pressed, raising the event every frame while the key is down and raising the event when the key is released. Options for the Mouse trigger include raising the event when the left mouse button is first pressed, raising the event while the left mouse button is depressed, raising the event when the left mouse button is first released, raising the event only if the mouse pointer is positioned over the Actor, raising the event if the mouse is hovering over the Actor, and raising the event when the mouse pointer leaves the area. Options for a timer trigger include every frame, randomly within a specified period (e.g., between five and twenty seconds) and every specified time interval (e.g., every 5 seconds).

Options for a collision trigger include when an Actor collides with another specified Actor, at the beginning of the collision, at the end of the collision or during the collision and when the first Actor is on top of the second Actor, when the first Actor is beneath the second Actor, when the first Actor is on the left of the second Actor and when the first Actor is on the right of the second Actor. Options for a Property Change trigger include when a specified Property changes to any value or when a Property changes to a value equal to, not equal to, greater than, less than, greater than or equal to, or less than or equal to a specified value.

Suppose, for example, a Game creator selects the Keyboard button for the trigger for a motion, e.g., Motion 1. In response to selection of the Keyboard button, an image of a keyboard may be displayed. In response to selection of the right arrow keyboard key from the image of the keyboard, the event of pressing the right arrow keyboard key is selected as the behavior that causes the move right behavior.

After the trigger for the motion event has been selected, a Motion user interface (e.g., Motion user interface 260 as illustrated in FIG. 2f) may be displayed which presents options for the following:

Selection of the type of motion, movement 262, rotation 264 or scale 266.

Selection of what the motion is relative to (Scene 268, Self 270, Actor 272, Mouse 274 or Point 276). For example, to make the Actor move up and down in the Scene, Scene 268 would be chosen. (Relative to Scene options include up, down, right, left or diagonal). If a Game player drives a car that moves in a forward direction, relative to Self 270 would be chosen. (Relative to Self options include forward, backward, strafe right, left or diagonal). Options for Actor 272 include chase, flee or orbit. Options for Mouse 274 include chase, flee or orbit. Options for Point 276 include move towards a destination, away from a destination or orbit a destination.

Selection of a direction for the motion. Available options depend on what was chosen in the previous steps.

Selection of the following: if the motion is going to have a maximum speed 278, apply an acceleration 280, or if the motion is a jumping motion 282.

Selection of how long the motion will be applied. Options are Forever 284, While Receiving Event 286, for a specified Duration 288 and for a specified Distance 290. Motion user interface 260 also provides a Preview Pane 254. Motion user interface 260 also includes a directional movement selector 292. Selectable directional movements include East, West, North, South, NorthEast, NorthWest, SouthEast and SouthWest.

For example, to specify in what direction the Actor (e.g., the hero Spaceship) will move the Motion button can be selected. In response, a new user interface will be displayed, with a graphic displaying directional movements (North East South West). For example for Motion 1, the East (E) motion direction can be selected. The While Receiving Event Button can be selected to specify the direction in which the Actor moves while the selected keyboard key is being depressed. Additional motions such as “move right”, etc. can be added. A “shoot” behavior can be added to the Actor by selecting a Shoot button, selecting the event that triggers the shooting behavior by selecting the Event button (e.g., pressing the keyboard's spacebar key could be selected to trigger the shooting behavior). Selecting one of the options Press, While Down or Release further can further define the shooting behavior. For example, selecting the Press button may cause the Actor to shoot once every time the key is pressed, selecting the While Down button may cause the Actor to shoot continuously while the selected key was depressed. Selecting Release may cause the Actor to shoot when the key is released.

To select what type of weapon the Actor will fire, the Projectile button can be selected. In response to selection of the Projectile button, an array of projectiles may be displayed. Upon selection of one of the projectiles from the array (e.g., Vertical Streak), the exit button may be selected. Upon selection of Motion button for the shooting behavior, user interface will be displayed. The shooting behavior can be set to be relative to the Scene, Self, Across, Mouse or Point (e.g., Scene). The direction can be selected (e.g., North). To add a sound effect to the firing of a projectile, the Sound button can be selected and one of the sound effects displayed can be selected (e.g., Classic Laser). Exiting the dialog returns the Game creator to the Actor user interface.

For example, to make the Flying Saucer enemy Actor 230 move back and forth across the top of the scene and shoot on their own, the Game creator could perform the following: click on the Flying Saucer enemy Actor in the Actor List 216, select the Behavior button 248, select the Motion button to add a new motion behavior, select the on load option for the event trigger, so that the motion will start as soon as the Actor appears in the Scene, select the Motion button for this behavior, set the motion direction to be East (E), set the Continue Moving choice to be For Distance, and set that value to be 140, select the Reverse When Done and Repeat Forever options and exit the Motion user interface. The shooting behavior can be set by selecting the shoot button, clicking on Event for the Shoot behavior, selecting the Timer option, and selecting the Random option within the Timer option. (A default of every 5 to 20 seconds can be selected or the Timer options can be set to other values.)

After exiting the Event user interface, a Projectile button for the shoot behavior can be selected, and one of Projectiles from the collection of displayed projections can be selected (e.g., Fire Bullet). Upon exiting from the Projectile chooser user interface, the Motion button for the shooting behavior can be selected, the Relative To setting set to Scene, and the South (S) motion for a downward motion selected. A sound can be selected to add a sound effect to the firing of the Projectile by clicking Sound and selecting one of the provided Sounds (e.g., DotGun). Exiting the Motion user interface returns the Game creator to the Actor user interface.

Suppose the default properties for the Actor includes a DisappearOnCollision behavior that makes the enemy Actor disappear when fired on. This will have the effect of having the enemy Actor disappear when fired on by another enemy Actor. To make the enemy Actors immune from enemy fire, the projectile that is fired from the enemy spaceships can be selected from the Game's Actor List 216. The Behavior button 248 can be selected. A DisappearOnCollision behavior may appear in the list of Behaviors for this Actor. By selecting the Event button for the DisappearOnCollision behavior, an option for raising the event when the projectile hits the hero Actor instead of raising the Event when the Projectile collides with any solid can be selected by selecting the Solids collidee button, selecting the Any instance option and setting the Actor to be the hero Actor.

To hook up the won scene to the Game, a SceneChange behavior can be added by going to the Scene user interface, selecting the Main scene, selecting Behaviors, adding a new Scene Change behavior, selecting the Event button for the new behavior and selecting the Property Change event. The Game keeps track of how many instances of an Actor there are so when there are no more enemy Actors, the Game player has won. Hence, a Game creator can select the Game tab 221, select “A scene” from the options, select the Main scene, and exit the chooser interface. Suppose in the Game being created, the player loses when the hero Actor (e.g., Fighter Spaceship) is destroyed (and thus disappears). To connect the Lost Scene to the Game, a Game creator could navigate to the Actors user interface, select the hero Actor, select the Behavior button 248, add a Scene Change behavior, select the Event button for the new behavior, change the Event from Load to Disappear, and exit the user interface. To connect events 314, the Scene button for the behavior can be selected and the Lost scene selected.

Optionally during Game development, a preview of the Game in its current state can be generated (318). When desired, the Game can be saved to stable storage (320).

### Example of a Suitable Computing Environment

In order to provide context for various aspects of the subject matter disclosed herein, FIG. 4 and the following discussion are intended to provide a brief general description of a suitable computing environment 510 in which various embodiments may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 4, a general purpose computing device in the form of a computer 512 is described. Computer 512 may include a processing unit 514, a system memory 516, and a system bus 518. The processing unit 514 can be any of various available processors. Dual microprocessors and other multiprocessor architectures also can be employed as the processing unit 514. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 512.

It will be appreciated that FIG. 4 describes software that can act as an intermediary between users and computer resources. This software may include an operating system 528 which can be stored on disk storage 524, and which can control and allocate resources of the computer system 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 4. Remote computer(s) 544 can be logically connected via communication connection 550. Network interface 548 encompasses communication networks such as local area networks (LANs) and wide area networks (WANs) but may also include other networks. Communication connection(s) 550 refers to the hardware/software employed to connect the network interface 548 to the bus 518. Connection 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein man pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 5 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages (e.g., Visual Basic, Visual J#, C++, C#, J#, Java Script, APL, COBOL, Pascal, Eiffel, Haskell, ML, Oberon, Perl, Python, Scheme, Smalltalk and the like). The IDE 600 may provide a native code development environment or may provide a managed code development that runs on a virtual machine or may provide a combination thereof. The IDE 600 may provide a managed code development environment using the NET framework. An intermediate language component 650 may be created from the source code component 610 and the native code component 611 using a language specific source compiler 620 and the native code component 611 (e.g., machine executable instructions) is created from the intermediate language component 650 using the intermediate language compiler 660 (e.g. just-in-time (JIT) compiler), when the application is executed. That is, when an IL application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

While the subject matter disclosed herein has been described in connection with the figures, it is to be understood that modifications may be made to perform the same functions in different ways.

What is claimed:

1. A method of creating a video game comprising:
creating a video game declaratively using a game creator executed by a processor of a computer, the video game comprising at least one scene;
creating the at least one scene, the at least one scene comprising at least one actor;
creating the at least one actor;
placing the at least one actor on the at least one scene by selecting the at least one actor from an actor list comprising actors selected for the video game and placing the selected at least one actor on the at least one scene;
setting properties on the at least one actor, on the at least one scene and on the video game, wherein properties of the video game persist throughout the video game and include a score property that maintains a game player's score for the video game and a mouse position property that maintains a current location of the video game player's mouse location;
selecting at least one behavior to associate with the at least one actor, wherein the at least one behavior associated with the at least one actor controls an interaction between the at least one actor and another actor in the video game;
selecting an event to trigger the at least one behavior associated with the at least one actor; and
connecting the selected event to the at least one actor.

2. The method of claim 1, further comprising:
generating a preview of the video game during development.

3. The method of claim 1, further comprising:
selecting at least one behavior to associate with the at least one scene;
selecting an event to trigger the at least one behavior associated with the at least one scene; and
connecting the selected event to the at least one scene.

4. The method of claim 1, further comprising:
filtering the event triggering the at least one behavior associated with the at least one actor declaratively by selecting an option of a plurality of options provided for the event on a user interface.

5. The method of claim 3, further comprising:
filtering the event triggering the at least one behavior associated with the at least one scene declaratively by selecting an option of a plurality of options provided for the event on a user interface.

6. The method of claim 1, wherein properties of the at least one actor include:
a mass property that determines a result of a collision between the at least one actor and another actor in the game.

7. The method of claim 1, wherein creating the video game comprises modifying an existing video game, or wherein creating the at least one scene comprises modifying an existing scene or wherein creating the at least one actor comprising modifying an existing actor.

8. A system that creates video games comprising:
a game creation component that exposes an object model for game creation via a set of application programming interfaces, the object model comprising a set of abstractions comprising game, scene and actor objects and the set of application programming interfaces and generates a video game; and
the set of application programming interfaces comprising user interfaces for creating the game, scene and actor objects, wherein a game object comprises at least one scene object and a scene object comprises at least one actor object, the game objects, scene objects and actor objects associated with built-in and user-defined properties, the set of application programming interfaces receiving user input comprising values to which the built-in and user-defined properties are set by the application programming interfaces for the game, scene and actor objects based on the user input.

9. The system of claim 8, wherein the set of application programming interfaces receives user input comprising behaviors for the actor objects of the game object, wherein behaviors specify interactions between actor objects.

10. The system of claim 9, wherein options for controlling an actor object include making the actor object move, changing a state of the actor object, making the actor object disappear from a scene object, making the actor object disappear from a scene object with a visual or sound effect, changing a property of the actor object, making the actor object shoot a projectile, adding a sound to the actor object or adding custom program code to the actor object.

11. The system of claim 8, wherein options for a directional movement of a motion behavior of an actor object comprise a movement to the north, northeast, south southeast, west, southwest, east or southeast.

12. The system of claim 8,
wherein the game creation component generates a preview of the video game.

13. A computer-readable storage medium comprising computer-executable instructions which when executed cause a managed computing environment to:
generate a set of application programming interfaces that receive user input and based on the received user input generate a video game, wherein the video game is developed by creating a game object, wherein the game object is comprised of at least one scene object, wherein the scene object is comprised of at least one actor object, wherein the game object has built-in and user-defined properties that persist throughout the video game, wherein the scene object has built-in and user defined properties that persist throughout a scene in the video game and wherein the actor object has built-in and user-defined properties that are changeable within a scene.

14. The computer-readable storage medium of claim 13, comprising further computer-executable instructions, which when executed cause the computing environment to:
receive user input via the set of application programming interfaces and based on the received input associate a behavior with the at least one scene object, wherein the behavior associated with the at least one scene object comprises a scene load event, a reaction to a current game state, a viewport move or a scene change.

15. The computer-readable storage medium of claim 13, comprising further computer-executable instructions, which when executed cause the computing environment to:
receive user input via the set of application programming interfaces and based on the received input associate at least one behavior with the at least one actor object, wherein the behavior associated with the at least one actor object comprises how the at least one actor object moves, in what direction the at least one actor object moves, how long the at least one actor object moves, or what type of weapon the actor object fires.

16. The computer-readable storage medium of claim 15, comprising further computer-executable instructions, which when executed cause the computing environment to:
receive user input via the set of application programming interfaces and based on the received input select an event to trigger the at least one behavior associated with the at least one actor object.

17. The computer-readable storage medium of claim 16, comprising further computer-executable instructions, which when executed cause the computing environment to:
connect the selected event to the at least one actor object.

18. The computer-readable storage medium of claim 17, comprising further computer-executable instructions, which when executed cause the computing environment to:
filter the event triggering the at least one behavior associated with the at least one actor by receiving a selected option of a plurality of options provided for the event on a user interface.

19. The computer-readable storage medium of claim 18, comprising further computer-executable instructions, which when executed cause the computing environment to:
receive user input via the set of application programming interfaces and based on the received input select an event to trigger the at least one behavior associated with the at least one scene object; and
connect the selected event to the at least one scene object.

20. The computer-readable storage medium of claim 16, comprising further computer-executable instructions, which when executed cause the computing environment to:
filter the event triggering the at least one behavior associated with the at least one scene by receiving a selected option of a plurality of options provided for the event on a user interface.
